(19) United States
(12) Patent Application Publication
(10) Pub. No.: US 2024/0406955 A1
(43) Pub. Date: Dec. 5, 2024

(54) TERMINAL AND BASE STATION IN WIRELESS COMMUNICATION SYSTEM SUPPORTING DISCONTINUOUS RECEPTION OPERATION, AND METHOD THEREFOR

(71) Applicant: Samsung Electronics Co., Ltd., Suwon-si (KR)

(72) Inventors: Haksung KIM, Suwon-si (KR); Yujin NAM, Suwon-si (KR); Kyungrae KIM, Suwon-si (KR)

(21) Appl. No.: 18/800,907

(22) Filed: Aug. 12, 2024

Related U.S. Application Data
(63) Continuation of application No. PCT/KR2023/002072, filed on Feb. 13, 2023.

(30) Foreign Application Priority Data
Feb. 11, 2022 (KR) 10-2022-0018395
Apr. 13, 2022 (KR) 10-2022-0045986

(51) Int. Cl. H04W 72/1268; H04L 1/08; H04W 72/21; H04W 76/28

(52) U.S. Cl. CPC H04W 72/1268; H04L 1/08; H04W 72/21; H04W 76/28

(57) ABSTRACT

The disclosure relates to a method for operating a base station in a wireless communication system, and discloses a method and apparatus which: receive periodic uplink control information (UCI) from a terminal in a connected discontinuous reception (C-DRX) on state; predict reception power of a scheduling request (SR) message based on reception power of the periodic UCI; based on a base station receiving, in a C-DRX off state, the SR message from the terminal, measure the reception power of the SR message; based on the measured reception power of the SR message and the predicted reception power of the SR message, set a maximum number of retransmissions of an UL grant that may be transmitted by the base station; retransmit the UL grant by the base station in response to the received SR message; and based on identifying that the number of retransmissions of the UL grant reaching the maximum number of retransmissions of the UL grant, determine that the base station does not receive the SR message.

### CROSS-REFERENCE TO RELATED APPLICATIONS

This application is a continuation of International Application No. PCT/KR2023/002072 designating the United States, filed on Feb. 13, 2023, in the Korean Intellectual Property Receiving Office and claiming priority to Korean Patent Application Nos. 10-2022-0018395, filed on Feb. 11, 2022, and 10-2022-0045986, filed on Apr. 13, 2022, in the Korean Intellectual Property Office, the disclosures of each of which are incorporated by reference herein in their entireties.

### BACKGROUND

### Field

The disclosure relates to a terminal and a base station and an operating method thereof in a wireless communication system supporting discontinuous reception operation.

### Description of Related Art

Efforts are being made to develop improved 5^{th}-generation (5G) or pre-5G communication systems to meet the growing demand for wireless data services after the development of 4^{th}-generation (4G) communication systems such as long-term evolution (LTE). Accordingly, the 5G or pre-5G communication system is also referred to as the ‘Beyond 4G Network’ or the ‘Post-LTE System’. In order to provide higher data rates, the 5G communication system may be implemented in higher frequency (mmWave) bands, for example, 60 GHz bands, compared to the 4G communication system. In order to reduce the propagation loss of radio waves and increase the transmission range, beamforming, massive multi-input multi-output (MIMO), full dimensional MIMO (FD-MIMO), array antenna, analog beamforming, and large-scale antenna technologies are being considered in 5G communication systems. In addition, in 5G communication systems, developments for improving system networks are being made based on evolved small cells, cloud radio access networks (cloud RANs), ultra-dense networks, device to device (D2D) communication, wireless backhaul, moving networks, cooperative communication, coordinated multi-points (CoMP), and reception-end interference cancellation. In the 5G communication systems, advanced coding modulation (ACM) such as hybrid FSK and QAM (FQAM) modulation and sliding window superposition coding (SWSC), and advanced access technologies such as filter bank multi carrier (FBMC), non-orthogonal multiple access (NOMA) and sparse code multiple access (SCMA) are being developed.

In order to provide higher data rates, the 5G communication system is being considered for implementation in higher frequency (mmWave) bands, for example, 60 GHz bands. In order to reduce the propagation loss of the radio waves and increase the transmission range, the beamforming, massive multi-input multi-output (MIMO), full dimensional MIMO (FD-MIMO), array antenna, analog beamforming, and large-scale antenna technologies are being discussed in 5G communication systems.

In addition, in 5G communication systems, developments for improving system networks are being carried out based on evolved small cells, cloud radio access networks (RANs), ultra-dense networks, device-to-device (D2D) communication, wireless backhaul, moving networks, cooperative communication, coordinated multi-points (CoMP), and reception-end interference cancellation.

On the other hand, the Internet is evolving from a human-centered connection network where people generate and consume information to an Internet of Things (IoT) network where information is communicated and processed between objects or other distributed components. The Internet of Everything (IoE) technology may be, for example, an example of a combination of big data processing technology and IoT technology through connection to a cloud server.

In order to implement the IoT, technology elements such as sensing technology, wired/wireless communication and network infrastructure, service interface technology, and security technology are required. Recently, research on inter-object connection technologies such as the sensor network, machine-to-machine (M2M), or the machine-type communication (MTC) is underway.

In the IoT environment, intelligent Internet technology (IT) services that generate new values in people's lives by collecting and analyzing data generated by interconnected objects may be provided. The IoT may have various applications such as smart homes, smart buildings, smart cities, smart cars or connected cars, smart grids, healthcare, smart home appliance industries, or advanced medical services through convergence or integration between existing IT technologies and various industries.

Accordingly, various efforts are being made to apply the 5G communication system to the IoT network. For example, the sensor network, machine-to-machine (M2M), the machine-type communication (MTC), or other 5G technologies are being implemented by methods such as beamforming, multi-input multi-output (MIMO), and array antenna methods. The application of the cloud wireless access network as a big data processing technology as described above may be referred to as an example of the convergence of the 5G and IoT technologies.

If a ghost scheduling request (SR) occurs when the discontinuous reception (DRX) state of a UE with connected DRX (C-DRX) configured is off (or, sleep), the UE cannot receive the UL grant message transmitted by a base station and the base station cannot receive uplink (UL) data corresponding to the UL grant message. Accordingly, since the base station continuously transmits UL grant messages, resources may be wasted, and if this situation persists, the connection between the base station and the terminal may be cut off.

### SUMMARY

In a method for a base station in a wireless communication system supporting C-DRX operation, an example embodiment of the disclosure may provide a method including: receiving at least one piece of uplink control information (UCI) periodically from a terminal, predicting reception power of a scheduling request (SR) message, based on reception power of the at least one piece of UCI, measuring the reception power of the SR message from the terminal, identifying that the SR message is received based on the measured reception power, setting the maximum number of retransmissions of an uplink (UL) grant capable of being transmitting by the base station based on the measured SR message reception power and the predicted SR message reception power, transmitting a UL grant corresponding to the SR message to the terminal, retransmitting the UL grant to the terminal, based on a failure to receive UL data responding to the UL grant from the terminal, and determining that the base station does not receive the SR message based on identifying that the number of retransmissions of the UL grant reaching the maximum number of retransmissions of the UL grant.

In a wireless communication system supporting connected discontinuous reception (C-DRX) operation, an example embodiment of the disclosure may provide a base station including: a transceiver and at least one processor comprising processing circuitry, individually and/or collectively, configured to: receive at least one piece of uplink control information (UCI) periodically from a terminal through the transceiver, predict reception power of a scheduling request (SR) message, based on reception power of the at least one piece of UCI, measure the reception power of the SR message through the transceiver from the terminal, identify that the SR message is received based on the measured reception power, set the maximum number of retransmissions of a UL grant capable of being transmitting by the base station based on the measured SR message reception power and the predicted SR message reception power, control the transceiver to transmit, by the base station, a UL grant corresponding to the SR message to the terminal, control the transceiver to retransmit the UL grant to the terminal, based on a failure to receive UL data responding to the UL grant from the terminal, and determine that the base station does not receive the SR message based on identifying that the number of retransmissions of the UL grant reaching the maximum number of retransmissions of the UL grant.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a diagram illustrating an example wireless communication system according to various embodiments;

FIG. 1B is a diagram illustrating an ON/OFF state of a UE according to a time of operating in a DRX mode according to various embodiments;

FIG. 2 is a flowchart illustrating example occurrence of an RLF after retransmission of a UL grant message according to various embodiments;

FIG. 3A is a flowchart illustrating example operation of a base station receiving a ghost SR according to various embodiments;

FIG. 3B is a flowchart illustrating an example operation of a base station for determining a ghost SR according to various embodiments;

FIG. 4 is a signal flow diagram illustrating example operations of a base station and a UE receiving a ghost SR according to various embodiments; and

FIG. 5 is a block diagram illustrating an example configuration of a wireless communication apparatus according to various embodiments.

### DETAILED DESCRIPTION

Other technical features may be readily apparent to those skilled in the art from the drawings, descriptions and claims below.

Before proceeding to the detailed description below, it may be desirable to describe the definition of specific words and phrases used throughout this disclosure. The term “couple” and its derivatives may refer to any direct or indirect communication between two or more elements, and whether they are in physical contact with each other. The terms “transmit”, “receive”, and “communicate” as well as their derivatives may include both direct and indirect communication. The terms “include” and “comprise” and their derivatives may refer to unlimited inclusion. The term “or” is a comprehensive term for and/or. “Associated with” and its derivatives may refer to include, be included within, interconnect with, contain, be contained within, connect to or with, couple to or with, be communicable with, cooperate with, interleave, juxtapose, be proximate to, be bound to or with, have, have a property of, have a relationship to or with, etc. The term “controller” may refer, for example, to arbitrary device, system, or part thereof that controls at least one operation. The controller may be implemented by hardware or a combination of hardware and software and/or firmware. Functions related to arbitrary particular controller may be centralized or distributed, either locally or remotely. The phrase “at least one of”, when used with a list of items, may refer, for example, to different combinations of one or more of the listed items that may be used, and that only one item in the list may be required. For example, “at least one of A, B, and C” includes any of the following combinations: A, B, C, A and B, A and C, B and C, and A, B and C. Similarly, the term “set” may refer to one or more. Accordingly, a set of items may be a single item or a collection of two or more items.

In addition, various functions described below may be implemented or supported by one or more computer programs, and each of which includes a computer-readable program code and is implemented in a computer-readable medium. The terms “application” and “program” may refer to one or more computer programs, software components, sets of instructions, procedures, functions, objects, classes, instances, related data, or parts thereof suitable for implementation in a suitable computer-readable program code. The phrase “computer-readable program code” includes all types of computer code, including source code, object code, and executable code. The phrase “computer-readable medium” includes all types of media that may be accessed by a computer, such as read only memory (ROM), random access memory (RAM), a hard disk drive, a compact disc (CD), a digital video disc (DVD), or any other type of memory. A “non-transitory” computer-readable medium excludes transmission of transitory electrical or other signals. A non-transitory computer-readable medium includes media on which data may be stored permanently, and media on which data may be stored and later overwritten, such as a rewritable optical disk or an erasable memory device.

Definitions for other specific words and phrases are provided throughout this disclosure. Those skilled in the art will recognize that in many, if not most, cases such definitions apply to prior as well as subsequent uses of the words and phrases so defined.

The drawings included herein and the various example embodiments used to illustrate the principles of the disclosure are for illustrative purposes only and should not be construed as limiting the scope of the disclosure. In addition, those skilled in the art will appreciate that the principles of the disclosure may be implemented in a suitably arranged wireless communication system.

3GPP TS 36.213 section 5.1.2 ‘Physical Uplink Control Channel’ may be included as a reference in the disclosure. “Antenna-related elements” is a set of components that may include RF chains, PF paths (mixers, power amplifiers, phase shifters, etc.), panels, physical antenna elements, etc.

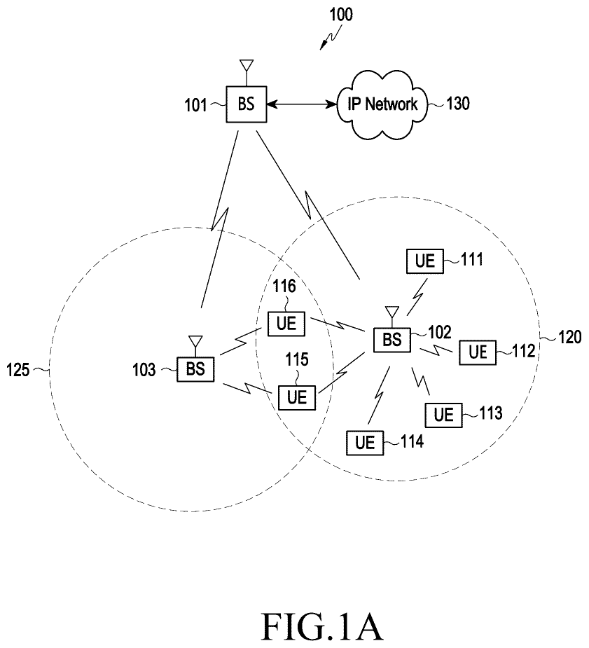

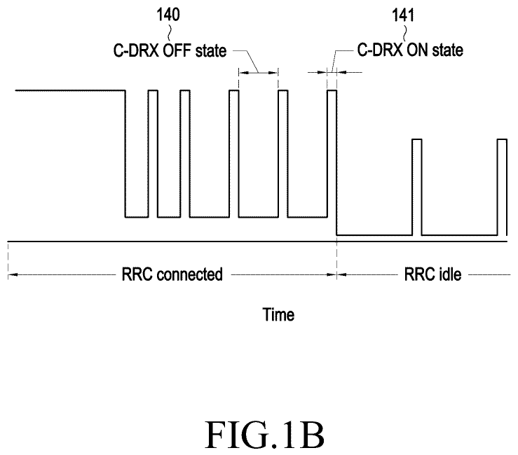

FIG. 1A is a diagram illustrating an example wireless communication system according to various embodiments.

FIG. 1A illustrates an example network computing system according to various embodiments. An example embodiment of the wireless network 100 illustrated in FIG. 1 is for illustrative purposes only. Various embodiments of the wireless network 100 may be used without departing from the scope of this disclosure.

As illustrated in FIG. 1A, the wireless network 100 includes a plurality of base stations (BSs), a gNodeB (gNB) 101, a gNB 102, and a gNB 103. The gNB 101 communicates with the gNB 102 and the gNB 103. In addition, the gNB 101 communicates with at least one network 130 such as the Internet, a proprietary Internet Protocol (IP) network, or another data network.

The gNB 102 provides wireless broadband access to the network 130 for a first plurality of user equipment (UE) within the coverage area 120 of the gNB 102. The first plurality of UEs include a UE 111 which may be located in a small business (SB); a UE 112 which may be located in an enterprise (E); a UE 113 which may be located in a Wi-Fi hot spot (HS); a UE 114 which may be located in a first residence (R); a UE 115 which may be located in a second residence (R); a UE 116 which may be a mobile device (M) such as a cellular phone, a wireless laptop, a wireless PDA, etc. The gNB 103 provides wireless broadband access to the network 130 for a second plurality of UEs within the coverage area 125 of the gNB 103. The second plurality of UEs include the UE 115 and the UE 116.

Based on the above network type, the term “base station” may refer to arbitrary component (or set of components) configured to provide wireless access to the network, such as a transmit point (TP), a transmit-receive point (TRP), a gNB, a macrocell, a femtocell, a Wi-Fi access point (AP), or other wireless enabled devices. The base stations may provide wireless access according to one or more wireless protocols, for example, 5G 3GPP new radio interface/access (NR), long-term evolution (LTE), LTE advanced (LTE-A), high speed packet access (HSPA), Wi-Fi 802.11a/b/g/n/ac, etc. In addition, based on the above network type, other known terms such as “terminal”, “mobile station”, “subscriber station”, “remote terminal”, “wireless terminal”, or “user device” may be used instead of “user equipment” or “UE”. For convenience, the terms “user equipment”, “UE” and “terminal” are used in this disclosure to refer to a remote wireless equipment that wirelessly accesses the gNB, regardless of whether the UE or terminal is a mobile device (such as a mobile phone or a smart phone) or should be considered as a normally fixed device (such as a desktop computer or a vending machine).

The dotted lines represent approximate sizes of the coverage areas 120 and 125, which are depicted as roughly circular for illustrative and descriptive purposes only. It should be clearly understood that the coverage areas associated with gNBs, such as the coverage areas 120 and 125, may have other forms including non-uniform forms based on the configuration of the gNBs and changes in the wireless environment associated with natural and artificial obstacles.

As described in greater detail below, the wireless network 100 may be a 5G communication system in which a UE, such as the UE 116, may communicate with a BS, such as the BS 102 for UE antenna adaptation to save power in BS and connected discontinuous reception (C-DRX). In an embodiment, antenna adaptation may be applied to reception (RX) antennas for download (DL) data reception based on a per bandwidth part (BWP) determined maximum MIMO layer. In an embodiment, antenna adaptation may be applied to transmission (TX) antennas for UL data transmission based on a per BWP determined maximum MIMO layer and/or maximum transmit antenna ports.

Although FIG. 1A illustrates an example of the wireless network 100, various modifications may be made with respect to FIG. 1A. As an example, the wireless network 100 may include arbitrary number of gNBs and arbitrary number of UEs in a suitable arrangement. In addition, the gNB 101 may communicate directly with arbitrary number of UEs and provide wireless broadband access to the network 130 to the UEs. Similarly, each gNB 102-103 may communicate directly with the network 130 and provide direct wireless broadband access to the network 130 to the UEs. In addition, the gNB 101, 102, and/or 103) may provide access to other or additional external networks such as external call networks or other types of data networks.

FIG. 1B is a diagram illustrating an example ON/OFF state of a UE according to a time of operating in a DRX mode according to various embodiments.

Referring to FIG. 1B, for example, an operation performed by a UE and/or a base station for transmission and reception during DRX ON duration to operate in a power saving mode may monitor a physical downlink control channel (PDCCH) during a DRX ON period 141 indicated by the power saving signal/channel so that the UE operates in the power saving mode. On the other hand, the UE may transmit a scheduling request (SR) to the network based on the data being allocated to the UE for transmission to the buffer.

In general, control information transmitted from a UE to a base station is collectively referred to as uplink control information (UCI). The UCI includes HARQ-ACK/NACK, scheduling request (SR), channel quality indicator (CQI), precoding matrix indicator (PMI), rank indication (RI) information, and the like. In LTE/LTE-A systems, the UCI is generally transmitted periodically through a physical uplink control channel (PUCCH), but may be transmitted through a physical uplink shared channel (PUSCH) when control information and traffic data must be transmitted simultaneously. In addition, the UCI may be transmitted aperiodically through PUSCH at the request/instruction of the network.

Referring to FIG. 1B, the power saving signal/channel may trigger the UE to wake up for the next concurrence(s) of the drx-onDurationTimer. For example, during DRX ON time 141, the UE may be configured by the base station to receive a PDCCH providing the UE with a DCI format capable of monitoring PDCCH candidates in search space sets associated with one or more subsequent DRX ON duration(s). For example, when the UE does not detect the DCI format, the UE does not monitor the PDCCH during one or more DRX ON duration(s) (as configured by higher layers).

For example, the period other than the DRX activation time in the RRC connected (RRC_CONNECTED) state may be referred to as a C-DRX OFF state 140 and a sleep state of the UE. In this period, when specific functions of the UE do not need to be performed, the power reduction state may be maintained for a predetermined period of time to save power, and power consumption may be reduced as hardware (e.g., LNA and/or RFIC) for reception does not operate. A communication channel such as a PDCCH may be monitored during the following one or more DRX ON periods 141.

Referring to FIG. 1B, the UE may transmit an SR message during one or more DRX ON period(s). When the base station receives the SR message of the UE, the base station may allocate uplink resources by transmitting a UL grant message to the UE. However, even though the UE did not transmit the SR message due to noise, interference, and device problems, the base station may determine that the SR message has been received (ghost SR or phantom SR).

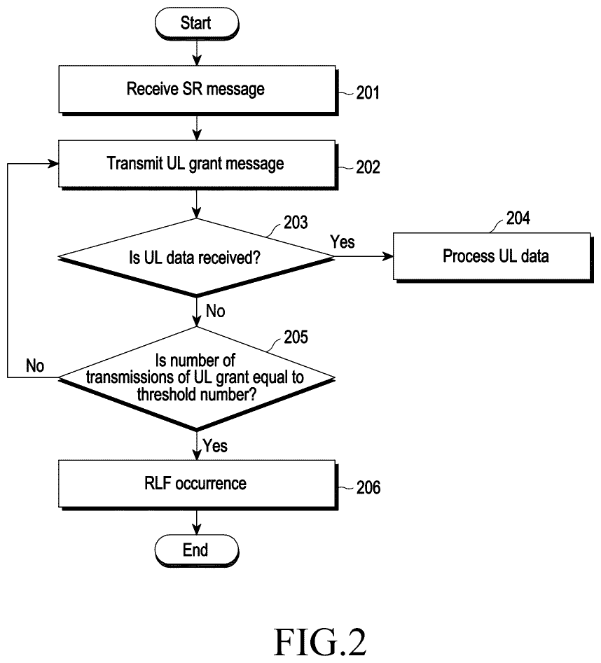

FIG. 2 is a flowchart illustrating example occurrence of an RLF after retransmission of a UL grant message according to various embodiments.

According to a comparative example for comparison with various embodiments, when the UE is configured with C-DRX and the DRX state is on, the UE may receive the message even if the base station transmits a UL grant message due to a ghost SR, so there may not be a major problem in operation although uplink resources may be slightly wasted. However, if the C-DRX is configured and the DRX state of the UE is off, the base station may transmit a UL grant message to the UE while the DRX state is off due to the ghost SR. In this case, since the UE cannot receive the UL grant message because the DRX state is off, the UE cannot transmit a message corresponding to the UL grant to the network. The network may transmit the UL grant message again because it cannot receive the message corresponding to the UL grant. In this case, the base station cannot identify whether the UE failed to receive the UL grant message or the UL data transmitted by the UE is damaged and could not be received, so the base station continues to transmit the UL grant message. If this situation persists, the connection between the base station and the UE may be cut off.

Referring to FIG. 2, in operation 201, the base station may receive an SR message of the UE. In operation 202, the base station may transmit a UL grant message to the UE based on the reception of the SR message. In operation 203, the base station may identify whether the uplink data is received. As an example, if the base station does not receive the uplink data (203—No), the base station may transmit a UL grant message to the UE, and if the base station receives the uplink data (203—Yes), the uplink data may be processed (operation 204). In operation 204, if the number of transmissions of the UL grant does not reach the threshold number (205—No), the base station receiving the UL data may transmit the UL grant to the UE again, and if the number of transmissions of the UL grant reaches the threshold number (205—Yes), in operation 206, the base station and/or the UE may determine that it is a radio link failure (RLF) and disconnect the connection between the base station and the UE.

As an example, when the base station receives the SR message from the UE, it may be a case where a ghost SR message is received. The base station may be configured to identify that the SR is received when the reception strength measured in the resources allocated to the SR exceeds a threshold. On the other hand, even though the UE did not actually transmit the SR message, there may be a case where the base station measures a reception strength exceeding the threshold based on various causes (e.g., noise or interference), and this may be conveniently referred to as reception of a ghost SR message.

Referring to FIG. 2, when the DRX state of the UE with C-DRX configured is off, if the base station transmits the UL grant message based on the ghost SR, the UE cannot receive the UL grant message transmitted by the base station and the base station cannot receive UL data. Accordingly, since the base station continuously transmits UL grant messages, resources may be wasted, and if this situation persists, the connection between the base station and the UE may be cut off.

Embodiments of the disclosure include a method for managing operations of a UE and a base station in a wireless communication system supporting C-DRX. As an example, for a base station, a device and method for efficiently recognizing a ghost SR through periodic measurement or prediction of the reception power intensity of a scheduling request (SR) are disclosed. As an example, a method for controlling the number of times a base station retransmits a UL grant message is disclosed.

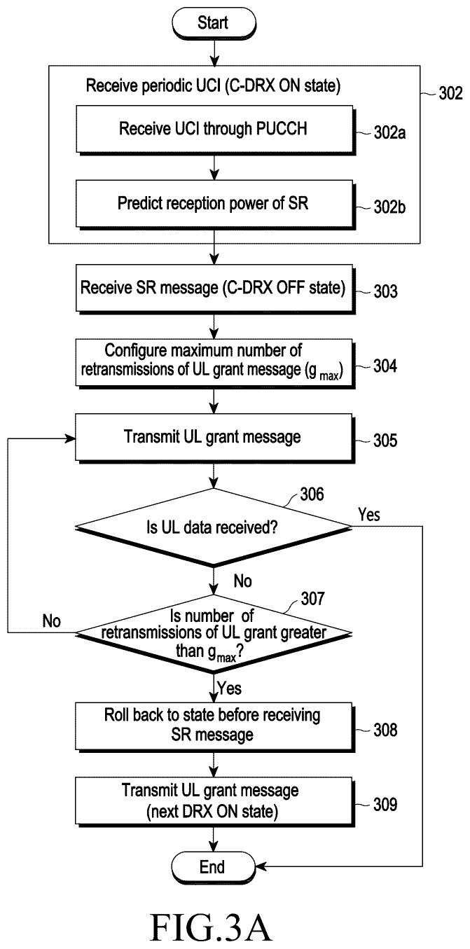

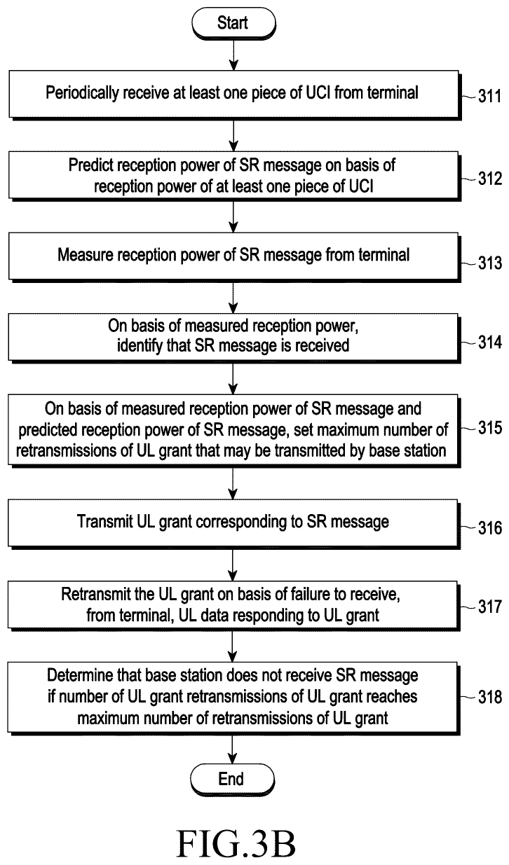

FIG. 3A is a flowchart illustrating an example operation of a base station receiving a ghost SR according to various embodiments.

According to an embodiment of the disclosure, in operation 301, the base station may periodically receive a UCI message when the C-DRX of the UE is in an ON state, and may configure the DRX period and ON/OFF start time. As an example, the base station may adjust the UCI transmission period and the offset of the UCI start time according to the offset of the DRX period and start time so that the base station may receive UCI messages periodically from the UE in an environment where the C-DRX operates.

According to an embodiment of the disclosure, in operation 302, the base station may periodically receive the UCI message from the UE through a PUCCH (302a), measure the reception power intensity of the UCI message, and based on this, predict the reception power intensity of the SR message (302b). As an example, if the offset of the UCI start time is adjusted, since the base station cannot receive a UCI message or an SR message when the UE is in a DRX OFF state, and the SR message is transmitted only when the UE needs the SR message, the base station may predict the reception power of the SR message (hereinafter, SR prediction value) through the reception of the UCI message when the UE is in the DRX ON state. As an example, the base station may continuously predict the reception power intensity (\hat{p}_{SR}) of the SR message based on the reception power intensity of the UCI message periodically received from the UE.

According to an embodiment of the disclosure, in operation 303, the base station may receive an SR in the C-DRX OFF state of the UE. As an example, the base station may measure the received SR power intensity (hereinafter, SR measurement value). In operation 304, the base station may compare the SR prediction value and the SR measurement value to determine the maximum number of UL grant message retransmissions. As an example, when receiving the SR message from the UE, in order to prevent and/or reduce malfunction due to a ghost SR, the base station may set the maximum number of UL grant message retransmissions (gₘₐₓ) based on the actual SR message received power intensity (P_{SR}) and the predicted SR reception power intensity (\hat{p}_{SR}) according to Equation 1.

$${g}_{max} = min ( 1 , α \cdot {p}_{SR} / {\hat{p}}_{SR} ) \times {g}_{default} \qquad [ Equation 1 ]$$

Here, α is a hyper parameter value for controlling the ratio of the reception power intensity, and g_{default} may be a default value for the number of UL grant retransmissions. As an example, g_{default} may be a default value configured for each base station before gₘₐₓ configured according to the disclosure. As an example, referring to Equation 1, according to the MIN function, as α increases, even if the SR measurement value is low, it operates according to the existing number of retransmissions, and as α decreases, even if the SR measurement value is high, the number of retransmissions determined as phantom SR decreases, so fast determination is possible and waste of resources may be reduced.

According to an embodiment of the disclosure, in operation 305, when receiving the SR message, the base station may transmit a UL grant and wait for UL data reception.

According to an embodiment of the disclosure, in operation 306, if the base station receives UL data (306—Yes), the base station may process the UL data. If the base station does not receive UL data (306—No), the number of transmissions of the UL grant message may be counted. In operation 307, if the number of transmissions of the UL grant message does not reach the maximum number of UL grant message retransmissions, the base station may transmit the UL grant to the UE again, and if the number of transmissions of the UL grant message reaches the maximum number of UL grant message transmissions (307—Yes), the base station may determine the received SR message as a ghost SR.

According to an embodiment of the disclosure, in operation 308, if the number of UL grant retransmissions reaches the maximum number of UL grant retransmissions (gₘₐₓ), the base station may determine that it is a ghost SR and roll back all states to the state just before receiving the SR message. As an example, since the lower the SR measurement value compared to the SR prediction value, the higher the probability that it is a ghost SR message, the maximum number of UL grant message retransmissions may be set low to minimize and/or reduce waste of resources. In this case, with respect to information on the UE within the range of the base station, the base station may recognize the UE state as a state in which the base station has not received the SR.

According to an embodiment of the disclosure, in operation 309, in order to prepare for the case where the base station mistakenly recognizes the state of the UE as not receiving the SR, the base station may transmit a UL grant message when the UE is in the DRX ON state again in the DRX period. As an example, in case that the UE does not receive the UL grant message due to a poor channel environment or the base station does not receive UL data despite the transmission of a normal SR message in the C-DRX OFF state, the base station may transmit a UL grant when the first C-DRX ON state is reached to provide an opportunity to transmit UL data. As an example, if the base station fails to receive UL data as many times as the number of UL grant retransmissions, even though the base station recognizes that the UE is in a state where the UE has not transmitted an SR message, the base station may not actually receive the SR message depending on the uplink channel status. In this case, the base station may perform an additional operation to identify whether the UE actually requested an SR by transmitting the UL grant message once more when the UE is in the ON state.

According to an embodiment of the disclosure, in relation to the configuration of the maximum number of UL grant retransmissions, if the SR measurement value is smaller than the SR prediction value, the number of retransmissions may be further reduced than the default value. As an example, if UL data is not received from the UE even though the UL grant is transmitted up to the maximum number of retransmissions, the base station may determine it as a ghost SR message and roll back the state of the UE managed by the base station to a state without transmitting the SR message.

FIG. 3B is a flowchart illustrating an example operation of a base station for determining a ghost SR according to various embodiments.

Referring to FIG. 3B, in operation 311, the base station may periodically receive at least one piece of UCI from the UE. In operation 312, the base station may predict the reception power of the SR message based on the reception power of the at least one piece of UCI. In operation 313, the base station may measure reception power of the SR message from the UE. In operation 314, the base station may identify that the SR message is received based on the measured reception power. In operation 315, the base station may set the maximum number of UL grant retransmissions that the base station may transmit, based on the measured SR message reception power and the predicted SR message reception power. In operation 316, the base station may transmit a UL grant corresponding to the SR message. In operation 317, the base station may retransmit the UL grant based on a failure of reception of UL data in response to the UL grant from the UE. In operation 318, when the number of UL grant retransmissions reaches the maximum number of UL grant retransmissions, the base station may determine the SR message as a ghost SR.

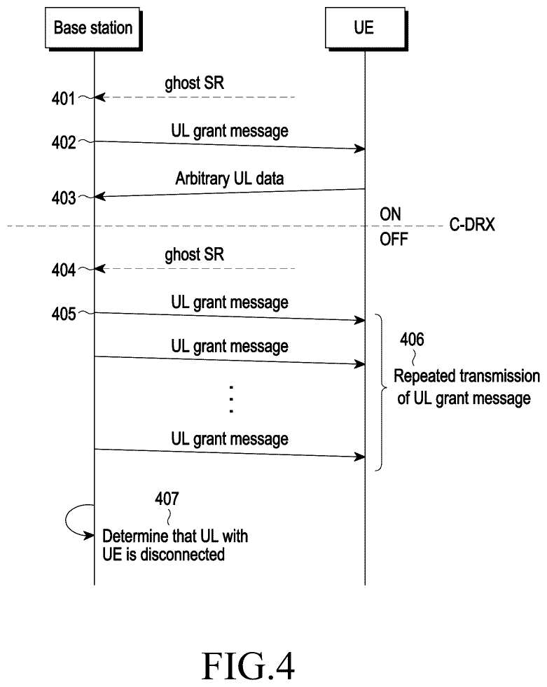

FIG. 4 is a signal flow diagram illustrating example operations of a base station and a UE receiving a ghost SR according to various embodiments.

Referring to FIG. 4, in operation 401, the base station may receive a ghost SR that the UE does not actually transmit. In operation 402, the base station may transmit a UL grant message to the UE in response thereto. As an example, when the UE is in the C-DRX ON state, even if the base station receives the ghost SR, it is not possible to identify whether it is a ghost SR or a normal SR message, so a UL grant message may be transmitted to the UE. In operation 403, since the UE is in the C-DRX ON state, the UE receiving the UL grant message may transmit arbitrary uplink (UL) data to the base station. In this case, even if the ghost SR message is received, a small amount of uplink resource may be wasted. In operation 404, when the UE is in the C-DRX OFF state, the base station may receive a ghost SR message. In operation 405, even if the base station receives the ghost SR message, it cannot determine whether it is a ghost SR message or a normal SR message, so the base station may transmit a UL grant message to the UE. However, since the UE cannot receive the UL grant message, the base station cannot receive the UL data. In operation 406, the base station may retransmit the UL grant message to the UE because it is difficult to know whether the UE has not received the UL grant message or whether the UL data has been damaged. As an example, since the base station allocates uplink resources that may be allocated to another UE to a UE that cannot transmit uplink during the retransmission duration of the UL grant message, the uplink resources of the base station may be repeatedly and unnecessarily wasted.

According to an embodiment of the disclosure, when the C-DRX ON state of the UE starts and the UE receives the UL grant while the base station repeatedly transmits the UL grant message, the UE may transmit UL data, and the repeated transmission of the UL grant message of the base station may be terminated.

According to an embodiment of the disclosure, in operation 407, the base station may determine the received SR message as a ghost SR message when the repeated transmission of the UL grant message reaches the maximum number of retransmissions of the UL grant message, even if the C-DRX ON state of the UE does not overlap while the base station repeatedly transmits the UL grant message. Accordingly, the base station may not determine that it is an RLF even if the base station continues not to receive UL data.

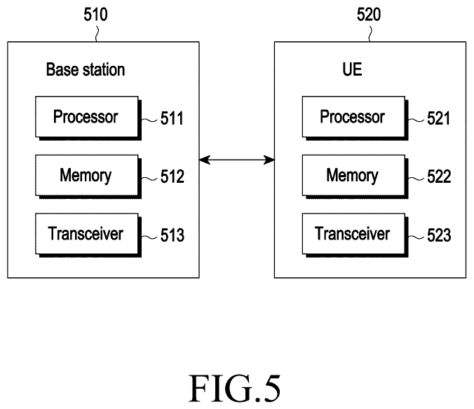

FIG. 5 is a block diagram illustrating an example configuration of a wireless communication apparatus according to various embodiments.

Referring to FIG. 5, the wireless communication system includes a base station 510 and a plurality of UEs 520 located within the base station 510 area. The base station 510 includes a processor (e.g., including processing circuitry) 511, memory 512, and a transceiver 513. The processor 511 implements the functions, processes, and/or methods illustrated in FIGS. 1A to 4. The layers of the wireless interface protocol may be implemented by at least one processor 511. Memory 512 is connected to the processor 511 to store various pieces of information for driving the processor 511. The transceiver 513 is connected to the processor 511 to transmit and/or receive a wireless signal. The UE 520 includes a processor (e.g., including processing circuitry) 521, memory 522, and a transceiver 523. At least one processor 521 implements the functions, processes, and/or methods disclosed in FIGS. 1A to 4. The layers of the wireless interface protocol may be implemented by the processor 521. Memory 522 is connected to the processor 521 to store various pieces of information for driving the processor 521. The transceiver 523 is connected to the processor 521 to transmit and/or receive a wireless signal. Memories 512 and 522 may be inside or outside the processors 511 and 521, and may be connected to the processors 511 and 521 by various well-known means. In addition, the base station 510 and/or the UE 520 may have a single antenna or a multiple antennas. Each of the processors 511 and 521 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an example embodiment of the disclosure, a method for a base station in a wireless communication system supporting connected discontinuous reception (C-DRX) operation, comprises: receiving at least one piece of uplink control information (UCI) periodically from a terminal, predicting reception power of a scheduling request (SR) message, based on reception power of the at least one piece of UCI, measuring the reception power of the SR message from the terminal, identifying that the SR message is received based on the measured reception power, setting the maximum number of retransmissions of an UL grant capable of being transmitting by the base station based on the measured SR message reception power and the predicted SR message reception power, transmitting a UL grant corresponding to the SR message to the terminal, retransmitting the UL grant to the terminal, based on a failure to receive UL data responding to the UL grant from the terminal, and determining that the base station does not receive the SR message based on identifying that the number of retransmissions of the UL grant reaching a maximum number of retransmissions of the UL grant.

According to an example embodiment of the disclosure, a method in which the base station further includes setting the period and starting time point of the UCI based on the period and starting time point of the C-DRX.

According to an example embodiment the received SR message is a ghost SR exceeding a threshold for reception power.

According to an example embodiment of the disclosure, the maximum number of retransmissions of the UL grant is set by gₘₐₓ=min(1, α·p_{SR}/\hat{p}_{SR})×g_{default}, wherein \hat{p}_{SR} is the predicted reception power of the SR message, P_{SR} is the measured reception power of the SR message, a is a hyper parameter for controlling the ratio of reception power, and g_{default} is a value specified to a base station for the number of retransmissions of an UL grant.

According to an example embodiment of the disclosure, the base station recognizes the received SR message as a ghost SR, and the base station returns to a state where the SR message is not received.

According to an example embodiment of the disclosure, wherein the base station sets the maximum number of retransmissions of the UL grant to be less than the specified number of retransmissions of the UL grant based on the ratio of the predicted reception power of the SR message to the measured reception power of the SR message being less than a threshold value.

According to an example embodiment of the disclosure, wherein the base station sets the maximum number of retransmissions of the UL grant to be less according to the decrease in the measured reception strength of the SR message.

According to an example embodiment of the disclosure, wherein the base station retransmits a UL grant to the terminal when a C-DRX on state arrives after a C-DRX off state.

According to an example embodiment of the disclosure, in a wireless communication system supporting connected discontinuous reception (C-DRX) operation, a base station comprises: a transceiver and at least one processor comprising processing circuitry, wherein at least one processor, individually and/or collectively, is configured to: receive at least one piece of uplink control information (UCI) periodically from a terminal through the transceiver, predict reception power of a scheduling request (SR) message, based on reception power of the at least one piece of UCI, measure the reception power of the SR message through the transceiver from the terminal, identify that the SR message is received based on the measured reception power, set a maximum number of retransmissions of an UL grant capable of being transmitting by the base station based on the measured SR message reception power and the predicted SR message reception power, control the transceiver to transmit a UL grant corresponding to the SR message through the transceiver to the terminal, control the transceiver to retransmit the UL grant to the terminal, based on a failure to receive UL data responding to the UL grant from the terminal, and determine that the base station does not receive the SR message based on identifying that the number of retransmissions of the UL grant reaching the maximum number of retransmissions of the UL grant.

According to an example embodiment of the disclosure, at least one processor, individually and/or collectively, is configured to set the period and starting time point of the UCI based on the period and starting time point of the C-DRX.

According to an example embodiment the received SR message is a ghost SR exceeding a threshold for reception power.

According to an example embodiment of the disclosure, at least one processor, individually and/or collectively, is configured to set the maximum number of retransmissions of the UL grant by gₘₐₓ=min(1, α·p_{SR}/\hat{p}_{SR})×g_{default}, wherein \hat{p}_{SR} is the predicted reception power of the SR message, P_{SR} is the measured reception power of the SR message, α is a hyper parameter for controlling the ratio of reception power, and g_{default} is a value prespecified to a base station for the number of retransmissions of an UL grant.

According to an example embodiment of the disclosure, at least one processor, individually and/or collectively, is configured to recognize the received SR message as a ghost SR, and return the base returns to a state where the SR message is not received, wherein the terminal recognizes that the SR message is not transmitted.

According to an example embodiment of the disclosure, at least one processor, individually and/or collectively, is configured to set the maximum number of retransmissions of the UL grant to be less than the specified number of retransmissions of the UL grant based on the ratio of the predicted reception power of the SR message to the measured reception power of the SR message being less than a threshold value.

According to an example embodiment of the disclosure, at least one processor, individually and/or collectively, is configured to set the maximum number of retransmissions of the UL grant to be lower according to the decrease in the measured reception strength of the SR message.

According to an example embodiment of the disclosure, at least one processor, individually and/or collectively, is configured to control the transceiver to retransmit a UL grant to the terminal based on a C-DRX on state arriving after a C-DRX off state.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for operating a base station in a wireless communication system supporting connected discontinuous reception (C-DRX) operation, the method comprising:
receiving at least one piece of uplink control information (UCI) periodically from a terminal;
predicting reception power of a scheduling request (SR) message, based on reception power of the at least one piece of UCI;
measuring the reception power of the SR message from the terminal;
identifying that the SR message is received based on the measured reception power;
setting a maximum number of retransmissions of an uplink (UL) grant capable of being transmitting by the base station based on the measured SR message reception power and the predicted SR message reception power;
transmitting a UL grant corresponding to the SR message to the terminal;
retransmitting the UL grant to the terminal, based on a failure to receive UL data responding to the UL grant from the terminal; and
determining that the base station does not receive the SR message based on identifying that the number of retransmissions of the UL grant reaching the maximum number of retransmissions of the UL grant.

2. The method of claim 1, further comprising setting the period and starting time point of the UCI based on the period and starting time point of the C-DRX by the base station.

3. The method of claim 1,
wherein the maximum number of retransmissions of the UL grant is set by gₘₐₓ=min(1, α·p_{SR}/\hat{p}_{SR})×g_{default},
wherein \hat{p}_{SR} indicates the predicted reception power of the SR message, P_{SR} indicates the measured reception power of the SR message, a indicates a hyper parameter for controlling the ratio of reception power, and g_{default} indicates a value specified to a base station for the number of retransmissions of an UL grant.

4. The method of claim 1, further comprising:
recognizing the received SR message as a ghost SR; and
returning to a state where the SR message is not received.

5. The method of claim 1, further comprising setting the maximum number of retransmissions of the UL grant to be less than the specified number of retransmissions of the UL grant based on a ratio of the predicted reception power of the SR message to the measured reception power of the SR message being less than a threshold value.

6. The method of claim 1, further comprising setting the maximum number of retransmissions of the UL grant to be less according to the decrease in the measured reception strength of the SR message.

7. The method of one of claim 1, further comprising retransmitting a UL grant to the terminal based on a C-DRX on state arriving after a C-DRX off state.

8. A base station in a wireless communication system configured to support connected discontinuous reception (C-DRX) operation, the base station comprising:
a transceiver; and
at least one processor, comprising processing circuitry,
wherein at least one processor, individually and/or collectively, is configured to:
receive at least one piece of uplink control information (UCI) periodically from a terminal through the transceiver;
predict reception power of a scheduling request (SR) message, based on reception power of the at least one piece of UCI;
measure the reception power of the SR message through the transceiver from the terminal;
identify that the SR message is received based on the measured reception power;
set the maximum number of retransmissions of an UL grant capable of being transmitting by the base station based on the measured SR message reception power and the predicted SR message reception power;
control the transceiver to transmit a UL grant corresponding to the SR message to the terminal;
control the transceiver to retransmit the UL grant to the terminal, based on a failure to receive UL data responding to the UL grant from the terminal; and
determine that the base station does not receive the SR message based on identifying that the number of retransmissions of the UL grant reaching the maximum number of retransmissions of the UL grant.

9. The base station of claim 8,
wherein at least one processor, individually and/or collectively, is configured to set the period and starting time point of the UCI based on the period and starting time point of the C-DRX.

10. The base station of claim 8,
wherein at least one processor, individually and/or collectively, is configured to set the maximum number of retransmissions of the UL grant based on gₘₐₓ=min(1, α·p_{SR}/\hat{p}_{SR})×g_{default},
wherein \hat{p}_{SR} indicates the predicted reception power of the SR message, P_{SR} indicates the measured reception power of the SR message, α indicates a hyper parameter for controlling the ratio of reception power, and g_{default} indicates a value prespecified to a base station for the number of retransmissions of an UL grant.

11. The base station of claim 8,
wherein at least one processor, individually and/or collectively, is configured to recognize the received SR message as a ghost SR, and to return the base station to a state where the SR message is not received.

12. The base station of claim 8,
wherein at least one processor, individually and/or collectively, is configured to set the maximum number of retransmissions of the UL grant to be less than a specified number of retransmissions of the UL grant based on a ratio of the predicted reception power of the SR message to the measured reception power of the SR message being less than a threshold value.

13. The base station of claim 8,
wherein at least one processor, individually and/or collectively, is configured to lower the maximum number of retransmissions of the UL grant based on a decrease in the measured reception strength of the SR message.

14. The base station of claim 8,
wherein at least one processor, individually and/or collectively, is configured to control the transceiver to retransmit a UL grant to the terminal based on a C-DRX on state arriving after a C-DRX off state.
